(19) United States
(12) Patent Application Publication
(10) Pub. No.: US 2011/0272552 A1
(43) Pub. Date: Nov. 10, 2011

(54) FLAG HOLDING DEVICE

(76) Inventor: BUDDY CHARLES JEFFRIES, Gallup, NM (US)

(21) Appl. No.: 12/774,614

(22) Filed: May 5, 2010

(51) Int. Cl. G09F 17/00

(52) U.S. Cl. 248/535

(57) ABSTRACT

A flag holding device for securing a flag to a vehicle may include a first portion, a second portion connected to the first portion to form an opening within an interior of the flag holding device, and a flag hole operable to accept a flag pole.

### BACKGROUND OF THE INVENTION

The present invention generally relates to a flag holding device, and more specifically relates to a device that securely attaches a flag on a flagpole onto vehicles such as motorcycles, trucks, and boats.

### SUMMARY OF THE INVENTION

In one aspect of the present invention, a flag holding device may comprise a first portion; a second portion connected to the first portion to form an opening within an interior of the flag holding device; and a flag hole operable to accept a flag pole

In another aspect of the present invention, a method of securing a flag may comprise securing a flag holding device around a bar and inserting a flag pole into a flag hole on the flag holding device.

These and other features, aspects and advantages of the present invention will become better understood with reference to the following drawings, description and claims.

### BRIEF DESCRIPTION OF THE DRAWINGS

FIG. 1 shows a perspective view of a flag holding device securing a flag to a bar in accordance with an embodiment of the present invention;

FIG. 2 shows an exploded view of the flag holding device of FIG. 1;

FIG. 3 shows a plan view of a component of the flag holding device of FIG. 1;

FIG. 4 shows a front elevation view of a component of the flag holding device of FIG. 1;

FIG. 5 shows a side elevation view of a component of the flag holding device of FIG. 1;

FIG. 6 shows a plan view of an end portion of the flag holding device of FIG. 1 in accordance with an embodiment of the present invention;

FIG. 7 shows a front elevation view of the end portion of FIG. 6;

FIG. 8 shows a side elevation view of the end portion of FIG. 6;

FIG. 9 shows a perspective view of a flag holding device in accordance with an alternate embodiment of the present invention;

FIG. 10 shows a perspective view of a flag holding device in accordance with an alternate embodiment of the present invention;

FIG. 11 shows a perspective view of a flag holding device in accordance with an alternate embodiment of the present invention; and

FIG. 12 shows a perspective view of the flag holding device of FIG. 1 secured to a passenger backrest.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provides a flag holding device that may allow a flag to be securely attached to a vehicle, such as a motorcycle, truck, or boat.

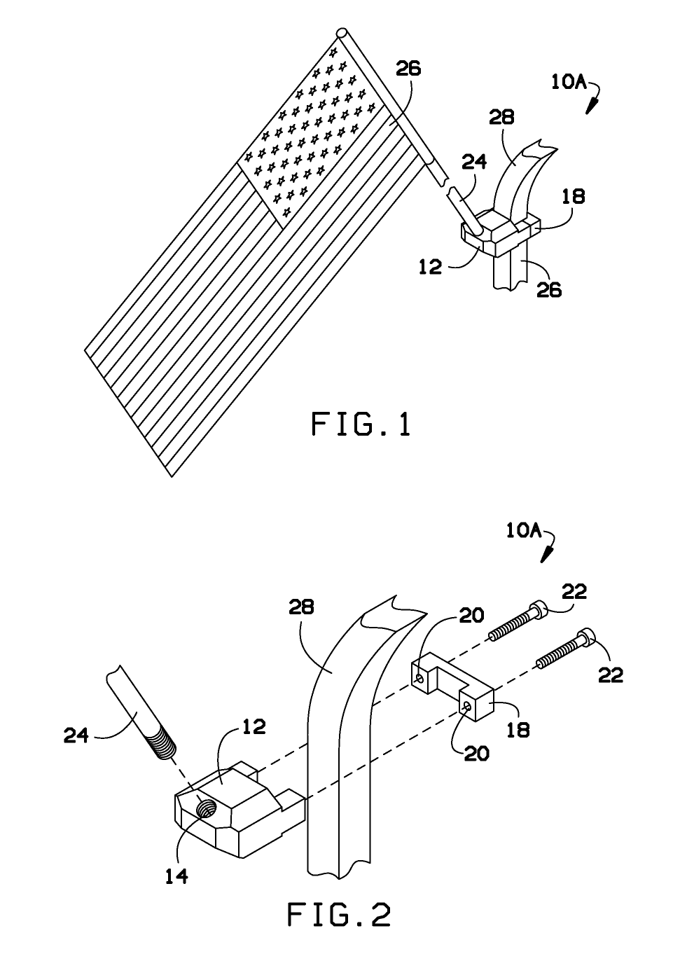

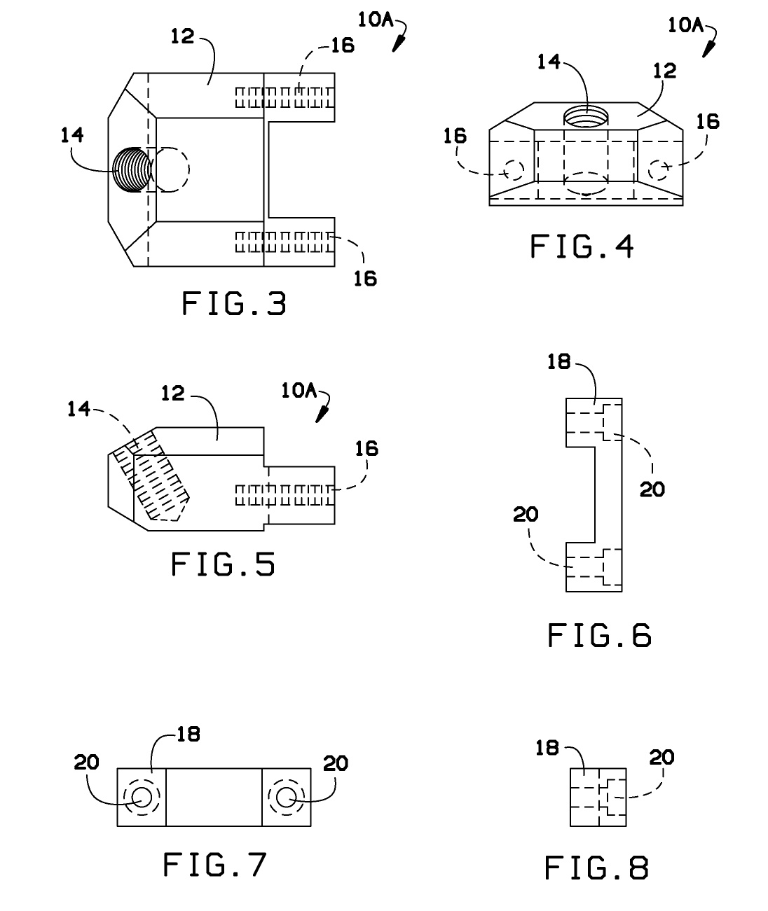

Referring to FIGS. 1-8, embodiments of the present invention may provide a flag holding device 10a that may comprise a flag holding portion 12 and an end portion 18. The flag holding portion 12 and the end portion 18 may both be U-shaped so that the two portions 12 and 18, when coupled, may form an opening in the interior of the flag holding device 10a. For example, the two portions 12 and 18 may be connected in order to securely surround and attach to a bar 26 that may be a portion of a passenger backrest of a motorcycle.

The flag holding portion 12 may comprise a threaded hole 14 bored into the flag holding portion 12 that may accept a pole portion of a flag 24. The pole portion of the flag 24 may have a threaded portion that may screw into the threaded hole 14, thereby securing the flag 24 to the flag holding portion 12. The threaded hole 14 may be angled so that a flag 24 attached to the flag holding portion 12 may be disposed at an acute angle coming out of the flag holding portion 12.

The end portion 18 may have a pair of end holes 20 that may accept screws 22. The flag holding portion 12 may also have connecting holes 16 that may accept the screws 22 coming out of the end holes 20. Thus, the screws 22 may connect the end portion 18 with the flag holding portion 12 by threading through the end holes 20 and then threading into the connecting holes 16 that line up with the end holes 20.

The end holes 20 may be counterbored holes or countersunk holes, and the screws 22 may be hex screws. The end portion 18, the flag holding portion 12, and the screws 22 may be made of any durable material, such as stainless steel, aluminum, or other metals.

In use, the flag holding portion 12 and the end portion 18 may be coupled around a bar 26 and the portions 12 and 18 may be connected via screws 22 threaded into the end holes 20 on the end portion 18 and the connecting holes 16 on the flag holding portion 12. A flagpole of the flag 24 may be threaded into the threaded hole 14, thereby securing the flag 24 to the bar 26.

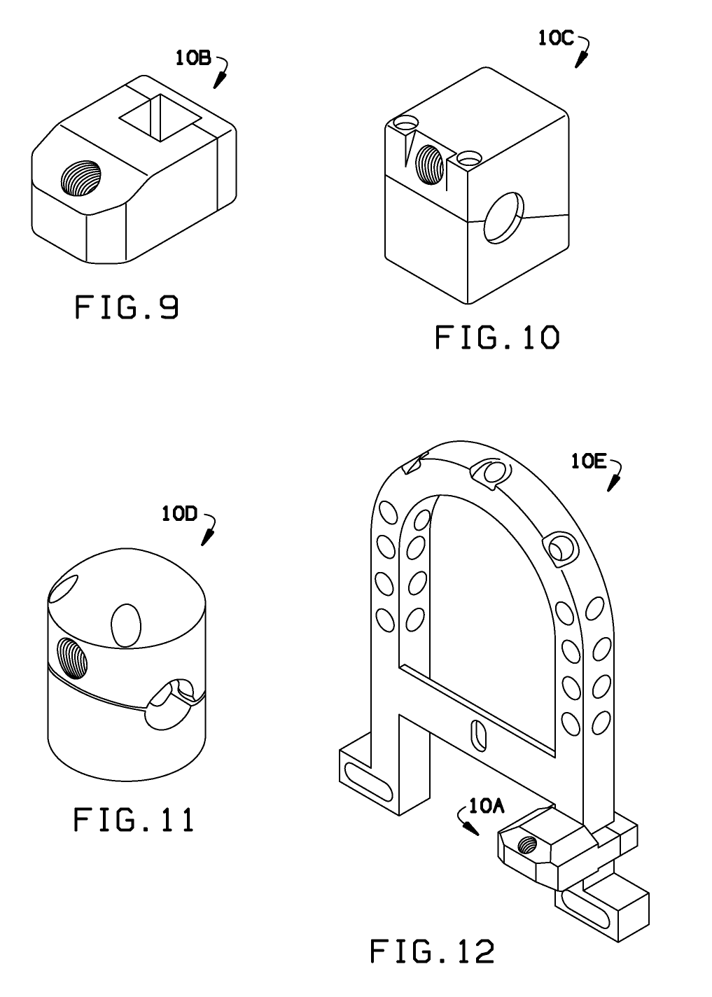

FIG. 9 shows a flag holding device 10b in accordance with an alternative embodiment of the present invention. As shown in FIG. 9, the flag holding device 10b may be operable to be secured around a square-shaped bar.

FIG. 10 shows a flag holding device 10c in accordance with an alternative embodiment of the present invention. As shown in FIG. 10, the flag holding device 10c may be operable to be secured around a horizontal cylindrical rod.

FIG. 11 shows a flag holding device 10d in accordance with an alternative embodiment of the present invention. As shown in FIG. 11, the flag holding device 10d may be operable to be secured around a horizontal cylindrical rod and may have a rounded domed top portion.

FIG. 12 shows a flag holding device 10a of FIG. 1 secured to a passenger backrest 10e, such as a motorcycle backrest.

It should be understood, of course, that the foregoing relates to exemplary embodiments of the invention and that modifications may be made without departing from the spirit and scope of the invention as set forth in the following claims.

We claim:

1. A flag holding device comprising:
a first portion;
a second portion connected to the first portion to form an opening within an interior of the flag holding device; and
a flag hole operable to accept a flag pole.

2. The flag holding device of claim 1 wherein:
the first portion comprises a first U-shaped portion having a first pair of legs; and
the second portion comprises a second U-shaped portion having a second pair of legs.

3. The flag holding device of claim 2, wherein the first pair of legs and the second pair of legs are connectable to form the flag holding device.

4. The flag holding device of claim 3, wherein the first pair of legs and the second pair of legs are connectable via screws.

5. The flag holding device of claim 4, wherein the first pair of legs includes first holes and the second pair of legs includes second holes that line up with the first holes, and further wherein the first holes and the second holes are operable to accept the screws.

6. The flag holding device of claim 1, wherein the flag hole is bored into the first portion.

7. The flag holding device of claim 1, wherein the flag hole is at an acute angle compared with the first portion.

8. A method of securing a flag comprising:
securing a flag holding device around a bar; and
inserting a flag pole into a flag hole on the flag holding device.

9. The method of claim 8, wherein the securing further comprises:
connecting a first U-shaped portion with a second U-shaped portion around the bar.

10. The method of claim 9, further comprising:
screwing the first U-shaped portion with the second U-shaped portion.
